(19) United States
(12) Patent Application Publication
(10) Pub. No.: US 2026/0347621 A1
(43) Pub. Date: Nov. 5, 2026

(54) METHOD FOR PRODUCING A POLYAMIDE POWDER

(71) Applicant: ARKEMA FRANCE, Puteaux (FR)

(72) Inventors: Geoffroy CAMMAGE, Serquigny (FR); Bakhta BOURSON, Colombes Cedex (FR); Guillaume LE, Serquigny (FR)

(73) Assignee: ARKEMA FRANCE, Puteaux (FR)

(21) Appl. No.: 19/118,526

(22) PCT Filed: Oct. 5, 2023
(86) PCT No.: PCT/FR2023/051554

§ 371 Date: Apr. 4, 2025

(30) Foreign Application Priority Data
Oct. 5, 2022 (FR) 2210208

(51) Int. Cl. C09D 5/03; B29B 9/12; B29K 77/00; B33Y 10/00; B33Y 40/10; B33Y 70/00; C08G 69/08; C08J 3/14; C09D 177/02

(52) U.S. Cl. CPC C09D 5/031; B29B 9/12; B33Y 40/10; B33Y 70/00; C08G 69/08; C08J 3/14; C09D 177/02; B29K 2077/00; B29K 2995/0094; B33Y 10/00; C08J 2377/02

(57) ABSTRACT

The invention relates to a process for producing a polyamide powder having a monomodal melting endotherm and a single melting temperature (T_{f1}^{max}), said process comprising the steps of:
i) contacting a polyamide with a solvent so as to obtain a mixture;
ii) heating the mixture so as to dissolve the polyamide in the solvent;
iii) cooling the mixture to the precipitation temperature (Tₚ) of the polyamide in said solvent, thereby obtaining a powder characterized by a non-monomodal melting endotherm and more than one melting temperature, (T_{f1}^{max}) being the highest melting temperature;
iv) maintaining the temperature of the mixture at a temperature at most equal to Tₚ, especially in the range from Tₚ −0.1 °C to Tₚ −15 °C, until the precipitated polyamide powder is characterized by a monomodal melting endotherm and a melting temperature (T_{f1}^{max}); and
v) recovering the polyamide powder obtained.

### FIELD OF THE INVENTION

The present invention relates to a process for producing a polyamide powder in which the difference between the melting temperature and the crystallization temperature (T_{f1}−T_{c}) of the polyamide powder is increased.

A large difference between the T_{f1} and T_{c} of a polyamide-based powder is useful in many applications and especially in the technology of powder agglomeration through melting or sintering induced by radiation such as a laser beam (laser sintering), infrared radiation or UV radiation or any source of electromagnetic radiation with which the powder can be melted so as to produce articles.

The present invention also relates to the polyamide powders obtained according to this process.

Lastly, the invention relates to the use of this powder and to the articles produced therefrom.

### PRIOR ART

The technology of agglomeration of polyamide powders under a laser beam is used to produce three-dimensional articles such as prototypes and models in various fields.

A thin layer of polyamide powder is deposited on a horizontal plate maintained in a chamber heated to a temperature that is between the crystallization temperature T_{c} and the melting temperature T_{f1} of the polyamide powder. The laser agglomerates the powder particles at different points in the powder layer according to a geometry corresponding to the article, for example using a computer having in its memory the shape of the article and reproducing this shape in the form of slices. The powder zones exposed to the laser solidify as soon as their temperature falls below the crystallization temperature T_{c}. The horizontal plate is then lowered by a distance corresponding to the thickness of a powder layer, then a new powder layer is deposited and the laser agglomerates the powder particles according to a geometry corresponding to this new slice of the article, and so on. The procedure is repeated until the entire article has been produced. An article surrounded by non-agglomerated powder is obtained inside the chamber. The assembly is then slowly cooled. Once it has cooled completely, the article is separated from the powder, which can be reused for another operation.

Immediately after the action of the laser beam, the temperature of the exposed zone is higher than the crystallization temperature (T_{c}) of the powder. However, if the temperature falls below this temperature too quickly, for example by applying a new, cooler layer of powder, this causes deformations (“curling”) in the workpiece being printed. Similarly, if the temperature of the powder approaches the melting temperature (T_{f1}) of the powder too closely, this leads to caking around the workpieces, manifested by the formation of lumps of powder that affect the printing quality.

To avoid these phenomena, it is therefore important for powders to be available that have a temperature To as far apart as possible from T_{f1}. The difference T_{f1}−T_{c} of the powder determines the working temperature window of the device used to agglomerate the powder particles by radiation-induced melting. This working window is defined by its upper temperature limit and its lower temperature limit. The upper limit of the working window corresponds to the temperature at which agglomeration or caking takes place. The lower limit of the working window corresponds to the temperature at which distortion or deformation or curling occurs. It is desirable for this working window to be greater than the variation in temperature within 3D printing machines, which is generally of the order of ±3 °C.

Moreover, a high melting enthalpy (ΔH_{f}) is advantageous so as to optimize geometric definition in the workpieces produced. Specifically, if it is too low, the energy supplied by the laser risks sintering, by thermal conduction, the powder particles surrounding the workpiece undergoing construction, which reduces geometric precision in the workpiece obtained.

It is clear that all that has just been said regarding the agglomeration of polyamide powders under a laser beam applies irrespective of the electromagnetic radiation that brings about melting and whether the melting process is selective or non-selective.

U.S. Pat. No. 5,932,687 discloses a process for preparing a precipitated polyamide powder having a narrow particle distribution and low porosity. This process comprises a first step of cooling the polyamide predissolved in an alcohol solvent to a temperature T₁ (higher than the precipitation temperature of the polyamide in the solvent) so as to achieve nucleation of the polyamide, followed by a second cooling step to achieve supersaturation of the medium and thus precipitation of the polyamide at a temperature T₂. The suspension obtained is directly cooled and dried to recover the polyamide powder.

US 2008/0166496 discloses a polyamide 11 powder employable in a powder agglomeration process, especially for the preparation of three-dimensional articles. These powders are prepared according to a process comprising a step of cooling the polyamide predissolved in ethanol to a temperature at which the polyamide precipitates. The heat generated by the precipitation keeps the medium at this temperature for 25 minutes, then the temperature reduces slightly and a 35-minute isotherm is carried out. At the end of this constant temperature phase, the mixture is cooled to isolate the precipitated polyamide powder.

However, the inventors had observed that the prior art processes afforded polyamide powders in which analysis by differential scanning calorimetry had in the first heating shown the presence of two temperature peaks associated with two relatively close but distinct melting temperatures, revealing the presence of distinct crystalline phases. For the reasons mentioned above, this heterogeneity in the thermal characteristics of the powder does however reduce the working window and is thus potentially detrimental to the quality of the articles produced by the process of powder agglomeration by melting with the aid of electromagnetic radiation, especially to their definition.

There is thus a real need for a process for preparing polyamide powders that are useful for technologies of powder agglomeration by electromagnetic radiation-induced melting, which process makes it possible for these drawbacks to be overcome.

### SUMMARY OF THE INVENTION

The inventors have now developed a dissolution/precipitation process that effectively increases the difference T_{f1}−T_{c} of existing polyamides, obtaining a monomodal melting endotherm.

More particularly, it was found that by introducing, at the end of the polyamide precipitation phase, a constant temperature phase of sufficient duration, it was possible to convert a powder characterized by a non-monomodal melting endotherm and more than one melting temperature (T_{f1}), (T_{f1}^{max}) being the highest melting temperature, into a polyamide powder characterized by a monomodal melting endotherm and a single melting temperature (T_{f1}) equal to (T_{f1}^{max}), and thus to increase the temperature difference (T_{f1}−T_{c}). The inventors were in particular able to demonstrate that this constant temperature phase made it possible for crystalline enhancement to take place and thus for a single crystalline phase to be obtained.

The polyamide powders obtained are thus particularly advantageous for use in a process of powder agglomeration by melting with the aid of electromagnetic radiation, especially in that they allow the working window to be widened and thus the quality and/or definition of the articles produced from these powders to be improved.

According to a first aspect, the object of the invention is thus to provide a process for producing a polyamide powder having a monomodal melting endotherm and a single melting temperature (T_{f1}^{max}), said process comprising the steps of:
i) contacting a polyamide with a solvent so as to obtain a mixture;
ii) heating the mixture so as to dissolve the polyamide in the solvent;
iii) cooling the mixture to the precipitation temperature (Tₚ) of the polyamide in said solvent, thereby obtaining a powder characterized by a non-monomodal melting endotherm and more than one melting temperature, (T_{f1}^{max}) being the highest melting temperature;
iv) maintaining the temperature of the mixture at a temperature at most equal to Tₚ, especially in the range from Tₚ −0.1 °C to Tₚ −15 °C, until the precipitated polyamide powder is characterized by a monomodal melting endotherm and a melting temperature (T_{f1}^{max}); and
v) recovering the polyamide powder obtained.

The process advantageously also has one or more of the additional features below. Thus, in some embodiments, the process according to the invention is a process:
wherein the solvent that is contacted with the polyamide is an alcohol, in particular a C₁-C₄ aliphatic alcohol, preferably ethanol;
wherein the heating of the mixture is performed at a temperature of from 100 °C to 200 °C, and preferably from 120 °C to 160 °C; and/or wherein the heating of the mixture is for a period of from 1 to 6 hours, and preferably from 1 to 3 hours;
wherein the cooling of the mixture in step iii) is performed at a rate of from 1 °C to 100 °C per hour and preferably from 10 °C to 60 °C per hour;
wherein the polyamide is polyamide 11, polyamide 6, or polyamide 10.10, or polyamide 10.12, or polyamide 6.10;
wherein the precipitation temperature Tₚ of the polyamide is between 80 °C and 130 °C, especially between 100 °C and 120 °C;
wherein, in step iv), the mixture is maintained at a temperature at most equal to Tₚ for a period of at least 2 hours, especially between 3 and 12 hours, commencing from the start of precipitation of the polyamide;
also comprising a step vi) of drying the precipitated polyamide powder recovered in step v) or obtained on conclusion of step iv), especially at a temperature of between 10 °C and 150 °C, more particularly between 50 °C and 100 °C; and/or
wherein the drying of the precipitated polyamide powder is performed at a pressure ranging from 10 mbar to atmospheric pressure.

According to a second aspect, an object of the present invention is also to provide a polyamide powder having a monomodal melting endotherm and a single melting temperature (T_{f1}^{max}) obtainable by the process according to the invention.

The powder advantageously in addition has one or more of the additional characteristics below.

Thus, in some embodiments, the powder is a powder:
characterized in that it has a volume mean diameter of between 10 and 200 μm, especially between 20 and 100 μm, and preferably between 40 and 80 μm;
characterized in that it has a diameter Dv10 of greater than 5 μm, especially between 10 and 70 μm, and preferably between 20 and 60 μm;
characterized in that it has a diameter Dv90 of less than 350 μm, especially between 30 and 200 μm, and preferably between 50 and 150 μm;
characterized in that it has a median diameter Dv50 of between 10 and 200 μm, especially between 20 and 100 μm, and preferably between 30 and 90 μm;
characterized in that it has a span factor of between 0.1 and 1.5, preferably between 0.1 and 1.0 and more preferably between 0.5 and 1.0;
wherein the polyamide is polyamide 11;
characterized in that it has a melting temperature (T_{f1}^{max}) of between 195 °C and 205 °C; and/or
wherein the difference between the melting temperature (T_{f1}^{max}) and the crystallization temperature (T_{c}) is between 35 °C and 45 °C.

According to a third aspect, the present invention also relates to a polyamide 11 powder having a monomodal melting endotherm and a single melting temperature (T_{f1}^{max}) of between 195 °C and 205 °C, having in addition at least one of the following characteristics:
a volume mean diameter of between 10 and 200 μm, especially between 20 and 100 μm, and preferably between 40 and 80 μm;
a diameter Dv10 of greater than 5 μm, especially between 10 and 70 μm, and preferably between 20 and 60 μm;
a volume median diameter Dv50 of between 10 and 200 μm, especially between 20 and 100 μm, and preferably between 30 and 90 μm;
a diameter Dv90 of less than 350 μm, especially between 30 and 200 μm, and preferably between 50 and 150 μm;
a span factor of between 0.1 and 1.5, preferably between 0.1 and 1 and more preferably between 0.5 and 1.0;
a melting enthalpy of greater than 100 J/g, and preferably between 110 and 160 J/g; and/or
an inherent viscosity of between 0.8 and 1.8, and preferably between 1.0 and 1.5. According to a fourth aspect, the invention provides a composition in powder form for 3D printing, especially by laser sintering, comprising:
a polyamide powder according to the invention; and
at least one filler or additive.

According to a fifth aspect, the invention relates to a process for producing polyamide articles by powder agglomeration by melting using electromagnetic radiation, the powder being as defined in the present description.

According to a sixth aspect, the invention relates to a manufactured article obtained by melting with the aid of electromagnetic radiation of a powder or composition according to the invention.

According to a seventh aspect, the invention provides for the use of a process according to the invention for increasing the difference (T_{f1}−T_{c}) between the melting temperature (T_{f1}) and the crystallization temperature (T_{c}) of a polyamide.

### FIGURES

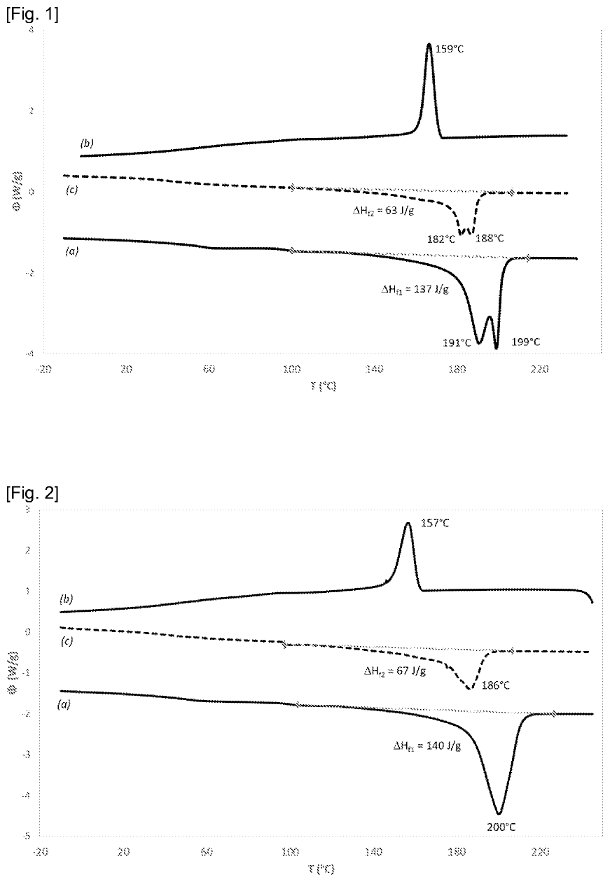

FIG. 1 depicts the thermograms illustrating heat flow Φ as a function of temperature, obtained by differential scanning calorimetry of polyamide 11 of comparative example 2, as follows:
(a): first heating, (b) subsequent cooling, and (c) second heating, with the corresponding melting enthalpy ΔH_{f};

FIG. 2 depicts the thermograms illustrating heat flow Φ as a function of temperature, obtained by differential scanning calorimetry of polyamide 11 of example 3, as follows:
(a): first heating, (b) subsequent cooling, and (c) second heating, with the corresponding melting enthalpy ΔH_{f}; and

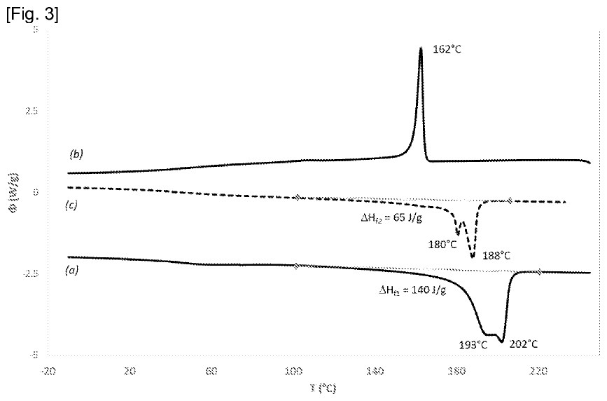

FIG. 3 depicts the thermograms illustrating heat flow Φ as a function of temperature, obtained by differential scanning calorimetry of polyamide 11 of comparative example 4, as follows:
(a): first heating, (b) subsequent cooling, and (c) second heating, with the corresponding melting enthalpy ΔH_{f}.

### DETAILED DESCRIPTION

The invention is now described in more detail and in a nonlimiting manner in the description that follows.

### Definitions

It should be noted that the expressions “from . . . to . . . ” and “between . . . and . . . ” used in the present description should be understood as including both of the limits mentioned.

The term “powder” is understood as referring to a solid material in finely divided form, which is generally provided in the form of particles of very small size, generally of the order of a few hundred micrometers or less.

The powders are generally characterized by thermograms obtained by differential scanning calorimetry (DSC) according to:
a first heating, which permits the melting of the polyamide powder to be characterized;
cooling, which permits the crystallization of the polyamide material to be characterized;
a second heating, which permits the melting of the polyamide material itself to be characterized.

The following terms are understood in the context of the thermal properties as being as defined in the standard ISO 11357-1:2016:
a “peak” refers to the part of the thermogram obtained by differential scanning calorimetry (DSC) that departs from the baseline to reach a local maximum or a local minimum and that then returns to the baseline. Such a peak may indicate a first-order transition (crystallization exotherm or melting endotherm); a melting peak may for the purposes of the present description especially comprise a plurality of peaks or shoulders before the signal returns to the baseline.
a “baseline” denotes the part of the recorded thermogram without any transition, in this case especially where there is no melting-or crystallization-type first-order transition. Within a transition zone it is possible to determine a virtual baseline: this is an imaginary line plotted through the transition zone assuming that the heat due to the transition is zero. The virtual baseline can be plotted by interpolating the baseline of the test specimen by means of a straight line;
a “peak area” refers to the area delimited by the peak and the interpolated virtual baseline. It is regarded as an enthalpy of transition, expressed in J/g. The term “melting enthalpy” is understood as referring to the heat required to melt the composition, corresponding to the area under the melting peak in the thermogram, measured according to the standard ISO 11357-3:2018.

The term “melting temperature” is understood as referring to the temperature representative of the melting phenomenon during which the at least partially crystalline polyamide powder or polyamide material passes into the viscous liquid state, as measured according to the standard ISO 11357-3:2018. Thus, for the purposes of the present description, a melting peak comprising a plurality of peaks or shoulders would be associated with a plurality of melting temperatures, namely one melting temperature for each peak or shoulder.

The “melting temperatures on first and second heating” are understood as meaning the melting temperatures, respectively denoted T_{f1} for first heating and T_{f2} for second heating, measured by DSC according to the standard ISO 11357-3:2018 and corresponding respectively to the maximum signal intensity of the melting peak on first heating and on second heating, both carried out with a temperature ramp of 20 °C/min. Thus, for the purposes of the present description, if a plurality of melting temperatures (T_{f1}) is detected on first heating, then the one to be used for calculating the difference (T_{f1}−T_{c}) is the T_{f1} temperature corresponding to the lowest melting temperature, namely T_{f1}^{min}. T_{f1}^{max} refers to the highest melting temperature (T_{f1}) and corresponds to the sole melting temperature (T_{f1}) obtained on conclusion of step iv).

The “crystallization temperature”, referred to hereinafter as T_{c}, is understood as meaning the temperature at which the at least partially crystalline compound passes from the viscous liquid state to the semicrystalline state, as measured according to the standard ISO 11357-3:2018, with a temperature ramp of −20 °C/min. The crystallization temperature corresponds more particularly to that measured during cooling after the first melting of the compound (first heating) and before the second melting (second heating), the first melting allowing the thermal history of the compound to be erased. Unless otherwise indicated, this is the temperature of the crystallization peak, corresponding to the maximum intensity of the DSC signal. Thus, for the purposes of the present description, if a plurality of crystallization temperatures is detected on cooling, then T. corresponds to the highest crystallization temperature and it is this value that must be used for calculating the difference (T_{f1}−T_{c}).

The “monomodal melting endotherm” of the polyamide powder is understood as meaning the part of the thermogram obtained by differential scanning calorimetry (DSC) corresponding to the first melting of the polyamide powder, and which is characterized by a single melting temperature T_{f1}. In other words, the melting peak corresponding to the first heating comprises only a single peak. In contrast, a multimodal melting endotherm is characterized by a melting peak on first heating having a plurality of peaks, i.e. a plurality of melting peak temperatures. Similarly, a melting endotherm in which the melting peak on first heating has a shoulder would not be considered a monomodal endotherm for the purposes of the present description.

The “precipitation temperature”, referred to hereinafter as Tₚ, is understood as meaning the temperature at which the mixture formed by the polyamide and the solvent used in the process passes from a homogeneous state to a heterogeneous state. The precipitation temperature is detected by means of a temperature sensor (PT100 type) coupled to a dynamic thermoregulation system (for example a “petite fleur” system sold by Huber). At the moment of precipitation, the thermoregulation system is unable to instantaneously compensate for the exothermicity. The precipitation temperature is also accurately detected as a perturbation of the derivative of the temperature of the reaction medium as a function of detected time. The temperature corresponding to the start of the perturbation of the derivative is regarded as the precipitation temperature (Tₚ).

The term “Dv50” means the value for the volume median diameter of the powder particles at which the volume-weighted cumulative particle diameter distribution function is equal to 50%. Similarly, “Dv10” and “Dv90” are respectively the corresponding diameters at which the volume-weighted cumulative particle diameter function is equal to 10% and 90% respectively. These values are measured according to the standard ISO 13319-1:2021, for example using a Coulter Counter Multisizer 3 particle size analyzer. The rules for the representation of results of a particle size distribution are given by the standard ISO 9276-parts 1 to 6.

The “span” factor is understood as meaning a factor characterizing the width of the particle size distribution, defined as: span=(Dv90-Dv10)/Dv50, the diameters “Dv10”, “Dv50”, and “Dv90” being as defined above.

The term “mean diameter” means the value for the volume mean diameter of the particles corresponding to the volume-weighted arithmetic mean of the particle diameters. This value is measured according to the standard ISO 13319-1:2021, for example using a Coulter Counter Multisizer 3 particle size analyzer.

The term “viscosity” is understood as referring to the inherent viscosity as measured in an Ubbelohde-type viscometer according to the standard ISO 307:2019, but using m-cresol as solvent and a temperature of 20 °C. The inherent viscosity has the dimension of an inverse concentration and is equal to the natural logarithm of the relative viscosity, all divided by the concentration of polymer dissolved in the solvent.

The term “3D printing” is understood as referring to a technique for producing workpieces by additive production whereby a powder is selectively melted by electromagnetic radiation such as a laser or infrared light.

### Process for Producing a Polyamide Powder

According to a first aspect, the object of the invention is thus to provide a process for producing a polyamide powder having a monomodal melting endotherm and a single melting temperature (T_{f1}^{max}), said process comprising the steps of:
i) contacting a polyamide with a solvent so as to obtain a mixture;
ii) heating the mixture so as to dissolve the polyamide in the solvent;
iii) cooling the mixture to the precipitation temperature (Tₚ) in said solvent, thereby obtaining a powder characterized by a non-monomodal melting endotherm and more than one melting temperature, (T_{f1}^{max}) being the highest melting temperature;
iv) maintaining the temperature of the mixture at a temperature at most equal to Tₚ, especially in the range from Tₚ to Tₚ −15 °C, until the precipitated polyamide powder is characterized by a monomodal melting endotherm and a single melting temperature (T_{f1}^{max}); and
v) recovering the polyamide powder obtained.

In the description that follows, the term “monomer” should be taken as meaning a “repeat unit”. A special case is where a repeat unit consists of the combination of a diamine with a diacid. Here, it is considered to be the combination of a diamine and a diacid, i.e. the diamine-diacid pair, that corresponds to the monomer. This is because the diamine and the diacid are unable to form amide functions on their own.

A “polyamide” is for the purposes of the invention understood as meaning the condensation products of lactams, amino acids or diamine-diacid pairs. It may be a homopolymer, i.e. a polymer resulting from the condensation of the same repeat unit, i.e. the same monomer, or else a copolymer resulting from the condensation of at least two repeat units, i.e. two different monomers, termed “comonomers”, i.e. at least one monomer and at least one comonomer (monomer different from the first monomer) to form a copolymer such as a copolyamide (abbreviated as CoPA), as defined hereinbelow.

A “copolyamide” (abbreviated as CoPA) is understood as meaning the products of polymerization of at least two different monomers selected from:
monomers of amino acid or aminocarboxylic acid type, and preferably α,ω-aminocarboxylic acids;
monomers of lactam type;
monomer pairs of “diamine-diacid” type resulting from the reaction between a diamine and a dicarboxylic acid; and
mixtures thereof with monomers having a different number of carbon atoms in the case of mixtures of a monomer of amino acid type and a monomer of lactam type.

These monomers may be linear or branched or substituted, as appropriate.

According to some embodiments, the polyamide is a homopolymer.

According to a first type, the polyamide results from the condensation of an aliphatic, cycloaliphatic or aromatic dicarboxylic acid, especially containing from 4 to 36 carbon atoms, preferably from 6 to 18 carbon atoms, and an aliphatic, cycloaliphatic or aromatic diamine, especially containing from 2 to 20 carbon atoms, preferably from 6 to 14 carbon atoms.

Examples of dicarboxylic acids include 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid, and isophthalic acid, but also dimerized fatty acids.

Examples of diamines include tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM), 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN), and piperazine (Pip).

The polyamide is advantageously selected from PA 4.6, PA 4.10, PA 4.12, PA 4.14, PA 4.18, PA 6.10, PA 6.12, PA 6.14, PA 6.18, PA 9.12, PA 10.10, PA 10.12, PA 10.14, and PA 10.18. In the notation PA X. Y, X represents the number of carbon atoms derived from the diamine residues and Y represents the number of carbon atoms derived from the diacid residues, in accordance with convention.

In certain embodiments, the polyamide is selected from polyamide 11, polyamide 6, polyamide 10.10, polyamide 10.12, or polyamide 6.10. Preferably, the polyamide is PA 11.

### Steps i) and ii)

The indefinite article “a” or the definite article “the” used before the term “polyamide” in the process according to the invention means, in the context of the present description, “at least one polyamide” and respectively “said at least one polyamide”.

Thus, in a first step i) “at least one” polyamide is contacted with a solvent so as to obtain a mixture.

Preferably, only one polyamide is used in the process.

It is however possible to use a mixture of two or more, especially two, polyamides. Preferably, such a mixture comprises a predominant polyamide, especially one representing more than 80% by weight of the total weight of polyamides used in step i), and such that coprecipitation of the polyamide mixture is obtained.

In certain embodiments, the solvent that is contacted with the polyamide may be selected from: ethanol, propanol, butanol, isopropanol, heptanol, formic acid, acetic acid, N-methylpyrrolidone, N-butylpyrrolidone, butyrolactam, and caprolactam.

Preferably, the solvent that is contacted with the polyamide is a C₁-C₄ aliphatic alcohol, more preferably ethanol, and even more preferably technical grade ethanol of 96% purity (containing water and denatured with 2-butanone and propan-2-ol).

The polyamide may have a weight fraction in the solvent of from 0.01 to 0.30; and preferably from 0.1 to 0.3. In particular, it may have a weight fraction of 0.01 to 0.05; 0.05 to 0.1; or 0.1 to 0.15 or 0.15 to 0.2; or 0.2 to 0.25; or 0.25 to 0.3.

The mixture obtained is then heated in step ii) to dissolve the polyamide, i.e. until a homogeneous mixture is obtained.

The heating of the mixture may especially be carried out at a temperature of between 100 °C and 200 °C, and preferably between 120 °C and 160 °C.

In certain embodiments, the heating of the mixture may for example be performed at a temperature of from 100 °C to 105 °C; or from 105 °C to 110 °C; or from 110 °C to 115 °C; or from 115 °C to 120 °C; or from 120 °C to 125 °C; or from 125 °C to 130 °C; or from 130 °C to 135 °C; or from 135 °C to 140 °C; or from 140 °C to 145 °C; or from 145 °C to 150 °C; or from 150 °C to 155 °C; or from 155 °C to 160 °C; or from 160 °C to 165 °C; or from 165 °C to 170 °C; or from 170 °C to 175 °C; or from 175 °C to 180 °C; or from 180 °C to 185 °C; or from 185 °C to 190 °C; or from 190 °C to 195 °C; or from 195 °C to 200 °C.

In certain embodiments, the heating of the mixture, especially the maintenance of the mixture at the dissolution temperature, may be for a period of from 1 to 6 hours, and preferably from 1 to 3 hours. Thus, the heating of the mixture may last from 1 hour to 1 hour and 30 minutes; or from 1 hour and 30 minutes to 2 hours; or from 2 hours to 2 hours and 30 minutes; or from 2 hours and 30 minutes to 3 hours; or from 3 hours to 3 hours and 30 minutes; or from 3 hours and 30 minutes to 4 hours; or from 4 hours to 4 hours and 30 minutes; or from 4 hours and 30 minutes to 5 hours; or from 5 hours to 5 hours and 30 minutes; or from 5 hours and 30 minutes to 6 hours.

In certain embodiments, the heating comprises at least one step in which the temperature is increased to reach a maximum temperature of between 100 °C and 200 °C, in particular between 120 °C and 160 °C.

In certain embodiments, the heating comprises at least one step in which the temperature remains essentially constant at a value of between 100 °C and 200 °C, in particular between 120 °C and 160 °C.

Step iii)

Next, in step iii), the mixture is cooled in order to bring about precipitation of the polyamide in the form of a powder.

The precipitation temperature (Tₚ) can vary for the same polyamide, depending on the solvent. Similarly, it can vary for the same solvent, depending on the polyamide. Specifically, the precipitation of the polyamide is accompanied by a release of heat leading to a slight rise in the internal temperature. At the end of precipitation, no more heat is released and the internal temperature goes back down to its nominal temperature.

This precipitation temperature may be between 80 °C and 130 °C, especially between 100 °C and 120 °C, particularly when the solvent is a C₁-C₄ aliphatic alcohol.

This cooling may be performed down to a temperature greater than or equal to 50 °C. Thus, the cooling may for example be performed down to a temperature of 50 °C. Thus, the cooling may for example be performed down to a temperature ranging from 50 °C to 60 °C; or from 60 °C to 70 °C; or from 70 °C to 80 °C; or from 80 °C to 90 °C; or from 90 °C to 100 °C; or from 100 °C to 110 °C; or from 110 °C to 120 °C; or from 120 °C to 130 °C.

In addition, this cooling may be performed at a rate of between 1 and 100 °C per hour, preferably between 10 and 60 °C per hour, and more preferably between 20 and 50 °C per hour. For example, the cooling may be performed at a rate of from 1 to 5 °C per hour; 5 to 10 °C per hour; 10 to 15 °C per hour; or from 15 to 20 °C per hour; or from 20 to 25 °C per hour; or from 25 to 30 °C per hour; or from 30 to 35 °C per hour; or from 35 to 40 °C per hour; or from 40 to 45 °C per hour; or from 45 to 50 °C per hour; or from 50 to 55 °C per hour; or from 55 to 60 °C per hour; or from 60 to 65 °C per hour; or from 65 to 70 °C per hour; or from 70 to 75 °C per hour; or from 75 to 80 °C per hour; or from 80 to 85 °C per hour; or from 85 to 90 °C per hour; or from 90 to 95 °C per hour; or from 95 to 100 °C per hour.

In certain embodiments, and in order to promote precipitation, an amount of polyamide may be introduced in step i) of loading the starting materials. Preferably, this amount of polyamide is less than or equal to 20% by weight, and preferably less than or equal to 10% by weight, relative to the total mass of polyamide used in this step. The polyamide may be identical to or different from that dissolved in the solvent, preferably identical. The polyamide may especially be selected from polyamide 11, polyamide 6, polyamide 10.10, polyamide 10.12, and polyamide 6.10. Thus, the added amount of polyamide may represent from 0.1% to 1% by weight; or from 1% to 2% by weight; or from 2% to 3% by weight; or from 3% to 4% by weight; or from 4% to 5% by weight; or from 5% to 8% by weight; or from 8% to 12% by weight; or from 12% to 16% by weight; or from 16% to 20% by weight, relative to the total mass of polyamide used in this step.

Step iii) is advantageously carried out with stirring. For a given stirring system, the stirring speed allows the volume mean diameter of the particles to be controlled. In general, as the stirring speed increases, the mean diameter of the polyamide particles reduces. Conversely, as the stirring speed reduces, the mean diameter of the polyamide particles increases.

### Step iv)

During the cooling step, when the precipitation temperature of the polyamide in said solvent is reached, a precipitation phase then commences. The start of this precipitation phase corresponds to the start of step iv) of the process according to the invention.

In step iv), the mixture is maintained at a temperature close to the precipitation temperature (Tₚ) of the polyamide in the solvent, which is at most equal to and especially within the range from −0.1 °C to −15 °C of this precipitation temperature, and this is maintained for a time sufficient to allow a precipitated polyamide powder having a monomodal melting endotherm and an increased melting temperature to be obtained.

In other words, the process includes in step iv) a constant temperature phase during which the temperature is kept constant for a time t. More particularly, the temperature is kept constant for the entire duration of the polyamide precipitation phase, namely a time t₁, and then for an additional time t₂ to allow for enhancement of the crystal lattice of the precipitated polyamide and thus for a polyamide powder having a monomodal melting endotherm and an increased melting temperature to be obtained.

As a rule, the time t₁ is much shorter than the time t₂ such that the total time t of the constant temperature phase is generally very close to t₂.

The additional time required to obtain a monomodal melting endotherm can be determined by analyzing samples collected at various intervals by differential scanning calorimetry (DSC) according to the standard ISO11357-3.

By way of example, on conclusion of the phase of precipitation of polyamide 11, i.e. at the end of time t₁, the inventors observed that a bimodal melting endotherm, characterized by two distinct melting temperatures, was obtained in the first heating in the DSC. By keeping the temperature constant at a temperature close to the precipitation temperature of the polyamide in the solvent for a sufficient additional time t₂, the inventors were able to observe the transformation of the bimodal melting endotherm of polyamide particles into a monomodal melting endotherm, reflected in the DSC thermogram by the disappearance of the peak associated with the lowest melting temperature in favor of the peak associated with the highest melting temperature. This constant temperature phase of total time t₁+t₂ thus advantageously makes it simultaneously possible for the difference T_{f1}−T_{c} to be increased and a monomodal melting endotherm to be obtained.

According to some embodiments, in step iv) the mixture is maintained at a constant temperature for a time t₂ of at least 2 hours, especially between 3 and 12 hours, preferably at least 4 hours, especially between 4 and 12 hours, commencing from the end of precipitation of the polyamide. This additional time after the end of the precipitation of the polyamide may be 2 to 3 hours; or 3 to 4 hours; or 4 to 5 hours; or 5 to 6 hours; or 6 to 7 hours; or 7 to 8 hours; or 8 to 9 hours; or 9 to 10 hours; or 10 to 11 hours; or 11 to 12 hours.

In certain embodiments, in step iv) the mixture is maintained at a constant temperature for a time t of at least 2 hours, especially between 3 and 12 hours, preferably at least 4 hours, especially between 4 and 12 hours, commencing from the start of precipitation of the polyamide. This time from the start of precipitation of the polyamide may be from 2 to 3 hours; or from 3 to 4 hours; or from 4 to 5 hours; or from 5 to 6 hours; or from 6 to 7 hours; or from 7 to 8 hours or from 8 to 9 hours; or from 9 to 10 hours; or from 10 to 11 hours; or from 11 to 12 hours.

### Steps v) and vi)

On conclusion of the constant temperature phase carried out in step iv), the precipitated polyamide particles are in step v) recovered from the mixture in powder form by conventional solid-liquid separation means.

This step generally comprises cooling the mixture obtained so that the reactor can be drained and the precipitated polyamide particles obtained then separated from the solvent, in particular by filtration.

The process for producing the polyamide powder may also comprise a step vi) of drying the polyamide powder obtained in step iv) or recovered in step v). The drying step may for example be carried out in an agitated or rotary dryer.

In certain embodiments, the drying may be carried out at a temperature of from 10 °C to 150 °C, especially from 50 °C to 100 °C, preferably from 25 °C to 85 °C, and more preferably from 70 °C to 80 °C. The drying may for example be performed at a temperature of from 10 °C to 20 °C; or from 20 °C to 30 °C; or from 30 °C to 40 °C; or from 40 °C to 50 °C; or from 50 °C to 60 °C; or from 60 °C to 70 °C; or from 70 °C to 80 °C; or from 80 °C to 90 °C; or from 90 °C to 100 °C; or from 100 °C to 110 °C; or from 110 °C to 120 °C; or from 120 °C to 130 °C; or from 130 °C to 140 °C; or from 140 °C to 150 °C; or from 150 °C to 160 °C.

In certain embodiments, the drying may be performed under reduced pressure of less than 100 mbar, preferably less than 50 mbar. Thus, the drying may be performed at a pressure of from 1 to 10 mbar; or from 10 to 20 mbar; from 20 to 30 mbar; from 30 to 40 mbar; from 40 to 50 mbar; from 50 to 60 mbar; from 60 to 70 mbar; from 70 to 80 mbar; from 80 to 90 mbar ; from 90 to 100 mbar; from 100 to 150 mbar; from 150 to 200 mbar; from 200 to 250 mbar; or from 250 to 300 mbar; or from 300 to 500 mbar; or from 500 to 700 mbar; or from 700 mbar to less than 1 bar (in absolute pressure).

As a variant, the drying may be performed at atmospheric pressure.

### Polyamide Powder Obtainable by the Production Process of the Invention

According to a second aspect, the invention relates to a polyamide powder having a monomodal melting endotherm and a single melting temperature (T_{f1} max) that is obtainable by the process as described above.

In certain embodiments, the polyamide powder has an inherent viscosity of from 0.8 to 1.7, and preferably from 1.0 to 1.5. Thus, the powder may for example have an inherent viscosity of from 0.8 to 0.9; or from 0.9 to 1.0; or from 1.0 to 1.1; or from 1.1 to 1.2; or from 1.2 to 1.3; or from 1.3 to 1.4; or from 1.4 to 1.5; or from 1.5 to 1.6; or from 1.6 to 1.7. In the above, the inherent viscosity is expressed in (g/100 g)⁻¹.

The inherent viscosity is measured using a micro-Ubbelohde tube. The measurement is performed at 20 °C on a 75 mg sample of powder at a concentration of 0.5% (m/m) in m-cresol. The inherent viscosity is expressed in (g/100 g)⁻¹ and is calculated according to the following formula:

Inherent viscosity=In(tₛ/t₀)×1/C, where C=m/p×100, in which tₛ is the flow time of the solution, t₀ is the flow time of the solvent, m is the mass of the sample the viscosity of which is being determined, and p is the mass of the solvent.

In certain embodiments, the precipitated polyamide powder may have a crystallization temperature (T_{c}) of from 100 °C to 200 °C, and preferably from 130 °C to 180 °C. The polyamide powder may in particular have a crystallization temperature of from 100 °C to 110 °C; or from 110 °C to 120 °C; or from 120 °C to 130 °C; or from 130 °C to 140 °C; or from 140 °C to 150 °C; or from 150 °C to 160 °C; or from 160 °C to 170 °C; or from 170 °C to 180 °C; or from 180 °C to 190 °C; or from 190 °C to 200 °C.

In certain embodiments, the polyamide powder has a melting enthalpy of greater than or equal to 60 J/g, preferably greater than or equal to 100 J/g. This melting enthalpy may be for example from 60 to 80 J/g; or from 80 to 100 J/g; or from 100 to 110 J/g; or from 110 to 120 J/g; or from 120 to 130 J/g; or from 130 to 140 J/g; or from 140 to 150 J/g; or from 150 to 160 J/g.

In certain embodiments, the polyamide powder may have a melting temperature T_{f1} of between 130 °C and 260 °C, and preferably of between 160 °C and 210 °C. In particular, the polyamide powder may have a melting temperature of from 130 °C to 140 °C; or from 140 °C to 150 °C; or from 150 °C to 160 °C; or from 160 °C to 170 °C; or from 170 °C to 180 °C; or from 180 °C to 190 °C; or from 190 °C to 200 °C; or from 200 °C to 210 °C; or from 210 °C to 220 °C; or from 220 °C to 230 °C; or from 230 °C to 240 °C; or from 240 °C to 250 °C; or from 250 °C to 260 °C.

The melting temperature (T_{f1}) of the precipitated polyamide powder is determined during the first heating, as explained above. According to the process of the invention, a single melting temperature of the polyamide is observed on conclusion of the constant temperature phase at the end of step iv).

In certain embodiments, the polyamide powder may have an apparent specific surface area of from 0.1 to 50 m²/g, and preferably from 1 to 10 m²/g. The precipitated polyamide powder may thus have a specific surface area of from 0.1 to 1 m²/g; or from 1 to 5 m²/g; or from 5 to 10 m²/g; or from 10 to 20 m²/g; or from 20 to 30 m²/g; or from 30 to 50 m²/g. The apparent specific surface area (SSA) is measured according to the BET (Brunauer-Emmett-Teller) method known to those skilled in the art. It is in particular described in The Journal of the American Chemical Society, volume 60, page 309, February 1938, and corresponds to the international standard ISO 9277:2010. The specific surface area measured according to the BET method corresponds to the surface porosity of the powder, i.e. including the surface area formed by the pores at the surface of the particles.

According to certain embodiments, the polyamide powder obtained by the process of the invention is characterized in that it has:
a volume mean diameter of between 10 and 200 μm, especially between 20 and 100 μm, and preferably between 40 and 80 μm;
a diameter Dv10 of greater than 5 μm, especially between 10 and 70 μm, and preferably between 20 and 60 μm;
a volume median diameter Dv50 of between 10 and 200 μm, especially between 20 and 100 μm, and preferably between 30 and 90 μm;
a diameter Dv90 of less than 350 μm, especially between 30 and 200 μm, and preferably between 50 and 150 μm;
a span factor of between 0.1 and 1.5, and preferably between 0.5 and 1.0;
a melting enthalpy of greater than 60 J/g, and preferably between 100 and 160 J/g;
an inherent viscosity of between 0.5 and 2.0, and preferably between 1.0 and 1.5.

In a preferred embodiment, the polyamide powder having a monomodal melting endotherm and a single melting temperature (T_{f1}^{max}) that is obtainable by the process is characterized in that it has a span factor of between 0.1 and 1.5, preferably between 0.1 and 1.0, and more preferably between 0.5 and 1.0.

### Polyamide 11 Powder

According to another aspect, the invention relates to a polyamide 11 powder characterized in that it has a monomodal melting endotherm and a single melting temperature on first heating T_{f1} equal to T_{f1}^{max} of between 195 °C and 205 °C, especially of about 200 °C, and/or a crystallization temperature T_{c} of between 150 °C and 165 °C, especially of about 158 °C.

The polyamide 11 powder is especially a powder characterized by one or more of the following characteristics, preferably by all of the following characteristics:
a volume mean diameter of between 10 and 200 μm, especially between 20 and 100 μm, and preferably between 40 and 80 μm;
a diameter Dv10 of greater than 5 μm, especially between 10 and 70 μm, and preferably between 20 and 60 μm;
a volume median diameter Dv50 of between 10 and 200 μm, especially between 20 and 100 μm, and preferably between 30 and 90 μm;
a diameter Dv90 of less than 350 μm, especially between 30 and 200 μm, and preferably between 50 and 150 μm;
a span factor of between 0.1 and 1.5, and preferably between 0.5 and 1.0;
a melting enthalpy of greater than 100 J/g, and preferably between 110 and 160 J/g;
an inherent viscosity of between 0.8 and 1.8, and preferably between 1.0 and 1.5.

Preferably, the polyamide 11 powder is characterized in that it has a monomodal melting endotherm, a single melting temperature on first heating T_{f1} equal to T_{f1}^{max} of between 195 °C and 205 °C, and a span factor of between 0.1 and 1.5, preferably between 0.1 and 1 and more preferably between 0.5 and 1.0.

### Composition in Powder Form for 3D printing, Especially by Selective Laser Sintering

According to yet another aspect, the invention relates to a composition in powder form for 3D printing, especially by selective laser sintering, comprising a polyamide powder as defined above, in combination with one or more customary fillers or additives, i.e. suitable for 3D printing technologies.

This composition is advantageously a ready-to-use composition.

This composition may comprise additives that help to improve the transformation properties of the powder for its use with 3D printing technologies.

The additives generally represent less than 5% by weight relative to the total weight of the composition. Preferably, the additives represent less than 1% by weight of the total weight of the composition. Additives include flow agents, stabilizers (light, in particular UV, and heat stabilizers), optical brighteners, dyes, pigments and energy-absorbing additives (including UV absorbers).

Flow agents include for example a hydrophilic or hydrophobic silica. The flow agent advantageously represents from 0.01% to 0.5% by weight relative to the total weight of composition. Preferably, the composition includes from 0.1% to 0.4% by weight of flow agent.

The composition may also comprise one or more fillers that make it possible in particular to improve the mechanical properties (breaking stress and elongation at break) of the workpieces obtained by 3D printing.

The fillers generally represent less than 50% by weight, and preferably less than 40% by weight, relative to the total weight of final powder. Fillers include reinforcing fillers, especially mineral fillers such as carbon black, talc, carbon or non-carbon nanotubes, fibers (glass, carbon, etc.), which are optionally milled.

The additives or fillers may be mixed with the polyamide before the polyamide powder production process, during the polyamide powder production process (for example, in step i) before dissolution of the polyamide or in step iv) after precipitation), or after the polyamide powder production process. Preferably, the additives are introduced after the polyamide powder production process, by mixing the polyamide powder with said additives.

The composition may comprise the polyamide in a proportion by weight of preferably greater than or equal to 80%, or 81%, or 82%, or 83%, or 84%, or 85%, or 86%, or 87%, or 88%, or 89%, or 90%, or 91%, or 92%, or 93%, or 94%, or 95%, or 96%, or 97%, or 98%, or 99%, or 99.1%, or 99.2%, or 99.3%, or 99.4%, or 99.5%, or 99.6%, or 99.7%, or 99.8%, or 99.9%, or 99.91%, or 99.92%, or 99.93%, or 99.94%, or 99.95%, or 99.96%, or 99.97%, or 99.98%, or 99.99%.

In some embodiments, the polyamide contained in the composition is polyamide 11.

In some embodiments, the polyamide 11 has a melting temperature (T_{f1}) of between 185 °C and 205 °C.

In some embodiments, the difference between the melting temperature (T_{f1}) and the crystallization temperature (T_{c}) of the polyamide 11 is between 35 °C and 45 °C.

### Use of a Polyamide Powder Obtained by the Process of the Invention, or of a Composition in Powder Form Comprising Same, in a Process of Powder Agglomeration by Melting

The invention also provides a process for producing a polyamide article by powder agglomeration by melting using electromagnetic radiation, the powder being a polyamide powder or a composition in powder form as defined above.

The electromagnetic radiation may be infrared, ultraviolet or visible radiation. Preferably, it is laser radiation (in which case the production process is known as selective laser sintering).

According to this process, a thin layer of powder is deposited on a horizontal plate maintained in a chamber heated to a temperature termed the build temperature. The term “build temperature” refers to the temperature at which the bed of powder of a constituent layer of a three-dimensional article under construction is heated during the process of layer-by-layer sintering of the powder. This temperature is chosen within the T_{f1}−T_{c} difference of the polyamide powder resulting from the production process, preferably between T_{f1} −5 °C and T_{c} +5 °C, and more preferably between T_{f1} −10 °C and T_{c} +10 °C. The electromagnetic radiation then supplies the energy required to sinter the powder particles at different points in the powder layer according to a geometry corresponding to an article (for example using a computer containing in its memory the shape of an article and reproducing this shape in the form of slices).

The horizontal plate is then lowered by a distance corresponding to the thickness of a layer of powder, and a new layer is deposited. The thickness of a layer is typically between 0.05 and 2 mm and generally of the order of 0.1 mm. The electromagnetic radiation supplies the energy required to sinter the powder particles into a geometry corresponding to this new slice of the article, and so on. The procedure is repeated until the article has been produced.

Powders are used in the process of agglomeration by melting or sintering. These powders may have a volume mean diameter of from 10 μm to 200 μm and advantageously have a volume mean diameter of between 20 and 100 μm.

Preferably, the volume mean diameter is between 40 and 80 μm.

The invention also relates to a manufactured article, especially one made by 3D printing, obtained by sintering with electromagnetic radiation of a powder as described above.

This article may be selected from prototypes and models, especially in the automotive, nautical, aeronautical, aerospace, medical (prostheses, hearing systems, cellular tissues, etc.), textile, clothing, fashion, decorative, housings for electronic devices, telephony, home automation, IT, and lighting fields.

More generally, the invention also relates to the use of a production process as described above for increasing the difference (T_{f1}−T_{c}) between the melting temperature (T_{f1}) and the crystallization temperature (T_{c}) of a polyamide.

### EXAMPLES

The examples that follow illustrate embodiments of the present invention, but without limiting it.

In all the examples that follow:
the particle size of the powders was characterized by measuring the particle size distribution on a Coulter Counter-Multisizer 3 device (Beckmann Coulter) in accordance with the standard ISO 13319-1:2021. From this, the volume mean diameter and the diameters Dv10, Dv50, and Dv90 were determined. The span value is calculated from these volume-mean diameters.
the analysis of the thermal characteristics is done by DSC according to the standard ISO 11357-3 “Plastics-Differential Scanning Calorimetry (DSC) Part 3: Determination of temperature and enthalpy of melting and crystallization”. The temperatures of particular interest here are the melting temperature during first heating (T_{f1}) and the crystallization temperature (T_{c}). Specifically, as is known to those skilled in the art (in the field of production of 3D articles by powder agglomeration by melting), the difference “T_{f}−T_{c}” corresponds to T_{f1}−T_{c}.
the inherent viscosity of the polyamides is measured in an Ubbelohde-type viscometer according to the standard ISO 307:2019, but using m-cresol as solvent and a temperature of 20 °C.
the acidity (which may be regarded as the concentration of COOH chain ends of the polyamide) and the basicity (which may be regarded as the concentration of NH₂ chain ends of the polyamide) are measured potentiometrically. The acidity is measured according to the following method: a sample of polyamide is dissolved in benzyl alcohol at a concentration of 0.6% by weight and this sample is then determined potentiometrically using a 0.02 N tetrabutylammonium hydroxide solution. The basicity is measured according to the following method: a polyamide sample is dissolved in meta-cresol at a concentration of 0.6% by weight and this sample is then determined potentiometrically using a 0.02 N perchloric acid solution.

### Example 1: Preparation of a Polyamide 11

The polyamide 11 is obtained by polycondensation of 11-aminoundecanoic acid in the presence of 3000 ppm of orthophosphoric acid used as catalyst. This PA 11 has an inherent viscosity of 1.40 in combination with a concentration of chain-end COOH groups equal to 55 mmol/kg and of chain-end NH₂ groups equal to 51 mmol/kg and also a melting temperature of 189 °C (second heating in DSC according to ISO 11357-3:2018).

### Example 2 (Comparative)

A reactor (1 L working volume) is loaded with 85 g of PA 11 produced in example 1 and 425 g of technical-grade ethanol (purity 96%), with mechanical stirring carried out using an impeller-type turbomixer. The stirrer is operated at a speed of 500 rpm throughout the test and the medium is then heated to 160 °C, followed by a one-hour isotherm to dissolve the polyamide 11. Controlled cooling at a rate of −60 °C/h down to 20 °C is carried out to precipitate the polyamide. The precipitation temperature is 120 °C. The reactor is then drained and the dispersion dried in an oven at 75 °C at atmospheric pressure.

The PA11 powder obtained has the following characteristics: an inherent viscosity of 1.25, a volume mean diameter of 66 μm and also diameters Dv10=33 μm, Dv50=75 μm, and Dv90=108 μm and thus a span=1.00. DSC analysis of this PA 11 powder shows a bimodal melting endotherm on first heating with two distinct peaks at 191 °C and 199 °C associated with a melting enthalpy of 137 J/g (FIG. 1), and also a single crystallization temperature T_{c}=159 °C. It is the lower of the two melting temperatures that is used to calculate the difference T_{f1}−T_{c}, which is thus equal to 32 °C.

### Example 3 (Inventive)

A reactor (1 L working volume) is loaded with 85 g of PA 11 produced in example 1 and 425 g of technical-grade ethanol (purity 96%) into a reactor, with mechanical stirring carried out using an impeller-type turbomixer. The stirrer is operated at a speed of 500 rpm throughout the test and the medium is then heated to 160 °C, followed by a one-hour isotherm to dissolve the polyamide 11. Controlled cooling at a rate of −60 °C/h down to 115 °C is carried out to precipitate the polyamide, followed by a 4-hour isotherm at this same temperature to allow crystalline enhancement. The precipitation temperature (Tₚ) is 120 °C. Controlled cooling is then restarted at this same rate of −60 °C/h down to 20 °C and the reactor then drained and the dispersion dried in an oven at 75 °C at atmospheric pressure.

The PA11 powder obtained has the following characteristics: an inherent viscosity of 1.28, a volume mean diameter of 40 μm and also diameters Dv10=27 μm, Dv50=42 μm, and Dv90=53 μm, thus a span=0.62. DSC analysis of this PA 11 powder shows a monomodal melting endotherm on first heating with a single melting temperature of 200 °C associated with a melting enthalpy of 140 J/g (FIG. 1), and also a single crystallization temperature T_{c}=157 °C (FIG. 2). The difference T_{f1}−T_{c} is now equal to 43 °C.

### Example 4 (Comparative) According to US 2008/0166496

A diamine-terminated PA 11 is prepared by polymerizing 250 g of 11-aminoundecanoic acid in the presence of 1.25 g of 4,4′-diaminocyclohexylmethane (PACM, mixture of isomers) and has an inherent viscosity of 1.42 in combination with a concentration of chain-end COOH groups equal to 19 mmol/kg and of chain-end NH₂ groups equal to 67 mmol/kg.

A reactor (1 L working volume) is loaded with 85 g of this diamine-terminated PA 11 and 425 g of technical-grade ethanol (purity 96%), with mechanical stirring carried out using an impeller-type turbomixer. The stirrer is operated at a speed of 500 rpm throughout the test. The medium is heated to 152 °C, followed by a one-hour isotherm at this temperature. The medium is then cooled to 112 °C at a rate of −25 °C/h and then maintained at this temperature for one hour. The precipitation temperature (Tₚ) is 112 °C. The medium is then cooled to ambient temperature at a rate of −25 °C/h. The reactor is then drained, the ethanol distilled off in an agitated dryer at 70 °C/400 mbar, and the powder then dried at 84 °C/20 mbar.

The PA11 powder obtained has the following particle size characteristics: a volume mean diameter of 89 μm and also diameters Dv10=65 μm, Dv50=93 μm, and Dv90=123 μm, thus a span=0.62. DSC analysis of this PA 11 powder shows a bimodal melting endotherm on first heating with a shoulder at 193 °C and a peak at 202 °C associated with a melting enthalpy of 140 J/g (FIG. 1), and also a single crystallization temperature T_{c}=162 °C (FIG. 3). It is the lower of the two melting temperatures that is used to calculate the difference T_{f1}−T_{c}, which is thus equal to 29 °C.

1. A process for producing a polyamide powder having a monomodal melting endotherm and a single melting temperature (T_{f1}^{max}), said process comprising the steps of:
i) contacting a polyamide with a solvent so as to obtain a mixture;
ii) heating the mixture so as to dissolve the polyamide in the solvent;
iii) cooling the mixture to the precipitation temperature (Tₚ) of the polyamide in said solvent, thereby obtaining a powder characterized by a non-monomodal melting endotherm and more than one melting temperature, (T_{f1}^{max}) being the highest melting temperature;
iv) maintaining the temperature of the cooled mixture at a temperature at most equal to Tₚ, until the precipitated polyamide powder is characterized by a monomodal melting endotherm and a melting temperature (T_{f1}^{max}); and
v) recovering the polyamide powder obtained.

2. The process as claimed in claim 1, wherein the solvent that is contacted with the polyamide is an alcohol.

3. The process as claimed in claim 1, wherein the polyamide is polyamide 11, polyamide 6, polyamide 10.10, polyamide 10.12, or polyamide 6.10.

4. The process as claimed in claim 1, wherein, in step iv), the mixture is maintained at a temperature at most equal to Tₚ for a period of at least 2 hours, commencing from the end of precipitation of the polyamide.

5. A polyamide powder having a monomodal melting endotherm and a single melting temperature (T_{f1}^{max}) that is obtainable by the process as claimed in claim 1.

6. The polyamide powder as claimed in claim 5, wherein the polymer has a median diameter Dv50 of between 10 and 200 μm.

7. The polyamide powder as claimed in claim 5, wherein the polymer has a span factor of between 0.1 and 1.5.

8. The powder as claimed in claim 5, wherein the polyamide is polyamide 11.

9. The powder as claimed in claim 8, wherein the polymer has a melting temperature (T_{f1}^{max}) of between 195 and 205 °C.

10. The powder as claimed in claim 8, wherein the difference between the melting temperature (T_{f1}^{max}) and the crystallization temperature (T_{c}) is between 35 and 45 °C.

11. A polyamide 11 powder having a monomodal melting endotherm and a single melting temperature (T_{f1}^{max}) of between 195 °C and 205 °C, having in addition at least one of the following characteristics:
a volume mean diameter of between 10 and 200 μm;
a diameter Dv10 of greater than 5 μm;
a volume median diameter Dv50 of between 10 and 200 μm;
a diameter Dv90 of less than 350 μm;
a span factor of between 0.1 and 1.5;
a melting enthalpy of greater than 100 J/g; and
an inherent viscosity of between 0.8 and 1.8.

12. A composition in powder form for 3D printing, comprising:
a polyamide powder as claimed in claim 5; and
at least one filler or additive.

13. A process for producing polyamide articles by powder agglomeration by melting using electromagnetic radiation, the powder being as defined in claim 5.

14. A manufactured article obtained by melting with the aid of electromagnetic radiation of a powder as claimed in claim 5.

15. The process as claimed in claim 1, wherein the process further comprises increasing a difference (T_{f1}^{min}−T_{c}) between a lowest melting temperature (T_{f1} min) and a crystallization temperature (T_{c}) of a polyamide.

16. The process as claimed in claim 1, wherein, in step iv), the mixture is maintained at a temperature within the range from Tₚ−0.1 °C to Tₚ−15 °C.

17. The process as claimed in claim 16, wherein, in step iv), the mixture is maintained at a temperature at most equal to Tₚ for a period of at least 2 hours, commencing from the end of precipitation of the polyamide.

18. The process as claimed in claim 16, wherein, in step iv), the mixture is maintained at a temperature at most equal to Tₚ for a period of 3 to 12 hours, commencing from the end of precipitation of the polyamide.
